(19) United States
(12) Patent Application Publication
(10) Pub. No.: US 2008/0275147 A1
(43) Pub. Date: Nov. 6, 2008

(54) ELECTROLYTE MATERIAL

(75) Inventors: Jyunichi TAYANAGI, Tokyo (JP); Susumu SAITO, Tokyo (JP); Adam Luke SAFIR, Santa Clara, CA (US)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 11/624,499

(22) Filed: Jan. 18, 2007

(51) Int. Cl. B01J 47/00

(52) U.S. Cl. 521/38

(57) ABSTRACT

To provide an electrolyte material having high electrical conductivity (ion exchange capacity) and a high softening temperature.

An electrolyte material comprising a copolymer containing repeating units represented by the following formula (1) and repeating units represented by the following formula (2):

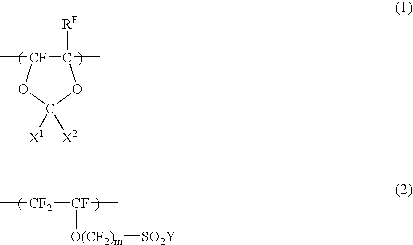

wherein R^{F} is a fluorine atom or the like, each of X¹ and X² is a fluorine atom or a trifluoromethyl group, m is from 2 to 4, and Y is a hydroxyl group or the like.

### BACKGROUND OF THE INVENTION

1. Field of the Invention

The present invention relates to a polymer electrolyte material (hereinafter referred to as an electrolyte material) to be used for e.g. a membrane-electrode assembly for a polymer electrolyte fuel cell (hereinafter referred to as a membrane-electrode assembly).

2. Discussion of Background

A fuel cell which employs hydrogen and oxygen presents no substantial effect to the global environment since its reaction product is only water in principle. A polymer electrolyte fuel cell which is one type of fuel cells has been mounted on a spaceship in the Gemini program and the Biosatellite program. However, the power density of the polymer electrolyte fuel cell at that time was low. Then, a higher performance alkaline fuel cell was developed, and an alkaline fuel cell was employed as a fuel cell for a spaceship (present space shuttle).

However, polymer electrolyte fuel cells are attracting attention again due to the progress of technology in recent years. The following reasons may be mentioned.

(1) An electrolyte membrane comprising a highly electrically conductive electrolyte material has been developed.

(2) A very high activity has been achieved by a supported catalyst having the catalyst to be employed for the catalyst layer of an electrode being supported on carbon, and further covered with an electrolyte material (ion exchange resin).

Thus, many studies have been conducted on a process for producing a membrane-electrode assembly for a polymer electrolyte fuel cell.

Polymer electrolyte fuel cells being studied at present have the drawback that the exhaust heat can hardly be utilized effectively for e.g. the auxiliary power of the fuel cell since its operation temperature is so low (from 50 to 120° C.). In order to compensate for the drawback, a high power density is required for the polymer electrolyte fuel cell. Further, in order for practical use of a polymer electrolyte fuel cell, development of a membrane-electrode assembly with which a high energy efficiency and a high power density can be obtained even under operation conditions where utilization rates of the fuel and the air are high, is required.

In recent years, it is required to operate a polymer electrolyte fuel cell at a relatively high temperature of at least 80° C., particularly at least 100° C. Accordingly, from the viewpoint of durability of the electrolyte membrane and the catalyst layer, an electrolyte material having a high softening temperature has been required.

As an electrolyte material which meets such a requirement, the following electrolyte materials have been proposed.

(1) An electrolyte material comprising a copolymer made by radical polymerization which contains repeating units based on a fluoromonomer A which provides a polymer having an alicyclic structure in its main chain, and repeating units based on a fluoromonomer B represented by CF₂═CF(R^{f})ⱼSO₂X (wherein j is 0 or 1, X is a fluorine atom, a hydroxyl group or the like, and R^{f} is a C₁₋₂₀ polyfluoroalkylene group which may contain an etheric oxygen atom) (JP-A-2002-260705).

(2) An electrolyte material comprising a copolymer made by radical polymerization which contains repeating units based on a perfluoromonomer A which provides a polymer having a cyclic structure in its main chain, and repeating units based on a monomer B represented by CF₂═CF—(OCF₂CFY¹)_{q}—Oₚ—(CF₂)ₙ—SO₂Y² (wherein Y¹ is a fluorine atom or a trifluoromethyl group, q is an integer of from 0 to 3, n is an integer of from 1 to 12, p is 0 or 1, provided that q+p>0, Y² is a hydroxyl group or NHSO₂Z¹, and Z¹ is a C₁₋₆ pefluoroalkyl group which may contain an etheric oxygen atom) (JP-A-2006-032157).

However, the electrolyte materials (1) and (2) have such a drawback that the softening temperature will be low when the ion exchange capacity is increased.

### SUMMARY OF THE INVENTION

Under these circumstances, the present invention is to provide an electrolyte material having high electrical conductivity (ion exchange capacity) and having a high softening temperature.

The electrolyte material of the present invention comprises a copolymer containing repeating units represented by the following formula (1) and repeating units represented by the following formula (2):

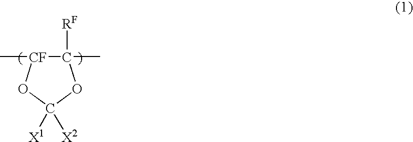

wherein R^{F} is a fluorine atom, a C₁₋₈ perfluoroalkyl group or a C₁₋₈ perfluoroalkoxy group, and each of X¹ and X² which are independent of each other, is a fluorine atom or a trifluoromethyl group,

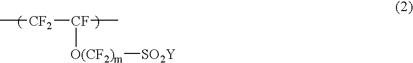

wherein m is an integer of from 2 to 4, and Y is a hydroxyl group or NHSO₂Z, wherein Z is a C₁₋₆ perfluoroalkyl group which may contain an etheric oxygen atom.

The repeating units represented by the above formula (1) are preferably repeating units represented by the following formula (1-1):

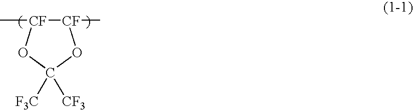

The electrolyte material of the present invention preferably contains from 0.5 to 80 mol % of the repeating units represented by the above formula (1) and from 5 to 40 mol % of the repeating units represented by the above formula (2).

The electrolyte material of the present invention preferably further contains repeating units based on tetrafluoroethylene.

In a case where the electrolyte material of the present invention contains repeating units based on tetrafluoroethylene, it preferably contains from 0.5 to 75 mol % of the repeating units represented by the above formula (1), from 5 to 40 mol % of the repeating units represented by the above formula (2) and from 5 to 85 mol % of the repeating units based on tetrafluoroethylene.

The ion exchange capacity of the electrolyte material of the present invention is preferably from 0.7 to 2.5 meq/g dry polymer.

The weight average molecular weight of the electrolyte material of the present invention is preferably from 20,000 to 2,000,000.

The electrolyte material of the present invention is used as the electrolyte material for a membrane-electrode assembly for a polymer electrolyte fuel cell.

The electrolyte material of the present invention has high electrical conductivity (ion exchange capacity) and has a high softening temperature.

### DETAILED DESCRIPTION OF THE PREFERRED EMBODIMENTS

In this specification, repeating units represented by the formula (1) will be referred to as repeating units (1). The same applies to repeating units represented by other formulae. Further, a compound represented by the formula (3) will be referred to as a compound (3). The same applies to compounds represented by other formulae

### (Electrolyte Material)

The electrolyte material of the present invention is a copolymer containing repeating units (1) and repeating units (2):

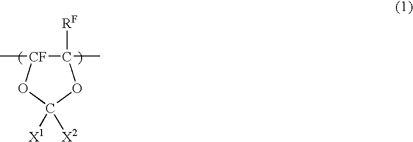

wherein RF is a fluorine atom, a C₁₋₈ perfluoroalkyl group or a C₁₋₈ perfluoroalkoxy group, and each of X¹ and X² which are independent of each other, is a fluorine atom or a trifluoromethyl group,

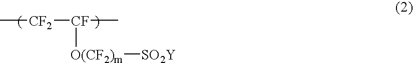

wherein m is an integer of from 2 to 4, preferably 2, Y is a hydroxyl group or NHSO₂Z, wherein Z is a C₁₋₆ perfluoroalkyl group which may contain an etheric oxygen atom.

The repeating units (1) may, for example, be repeating units (1-1) to (1-4), and preferred are repeating units (1-1), whereby the softening temperature of the electrolyte material to be obtained can be effectively increased even when the proportion of the repeating units (1) is low.

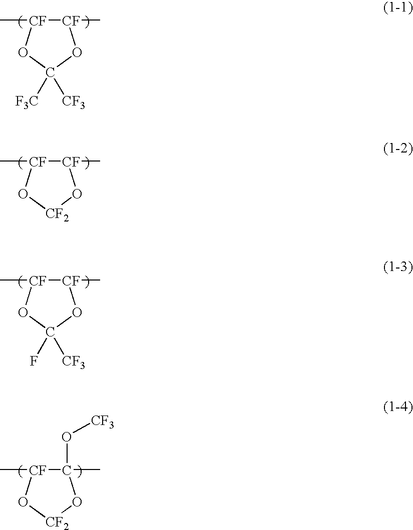

The amount of the repeating units (1) is preferably from 0.5 to 80 mol %, more preferably from 1 to 80 mol %, furthermore preferably from 4 to 70 mol %, particularly preferably from 10 to 70 mol % of the entire repeating units (100 mol %). When the amount of the repeating units (1) is at least 0.5 mol %, an electrolyte material having a high softening temperature will be obtained. When the amount of the repeating units (1) is at most 80 mol %, an electrolyte material having sufficient electrical conductivity (ion exchange capacity) will be obtained. In a case where repeating units based on another monomer described hereinafter are repeating units based on tetrafluoroethylene, the amount of the repeating units (1) is preferably from 0.5 to 75 mol % of the entire repeating units (100 mol %).

The repeating units (2) are preferably repeating units (2-1), whereby an electrolyte material having a higher softening temperature will be easily obtained, and a higher density of functional groups (—SO₂Y groups) will be achieved at the same proportion of the repeating units (2).

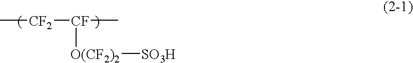

The amount of the repeating units (2) is preferably from 5 to 40 mol %, more preferably from 10 to 40 mol %, furthermore preferably from 15 to 35 mol %, particularly preferably from 17 to 30 mol % of the entire repeating units (100 mol %). When the amount of the repeating units (2) is at least 5 mol %, an electrolyte material having sufficient electrical conductivity (ion exchange capacity) will be obtained. If the amount of repeating units (2) exceeds 40 mol %, the swelling level of the electrolyte material in water may be too large or the electrolyte material may dissolve into water, or the softening temperature of the electrolyte material may be insufficient.

The electrolyte material of the present invention may contain repeating units based on another monomer described below, so as to adjust the mechanical property. A copolymer containing only repeating units (1) and repeating units (2) has a rigid back bone and accordingly when used as an electrolyte material or a catalyst layer for a polymer electrolyte fuel cell, the electrolyte membrane or the catalyst layer tends to be brittle.

Among repeating units based on another monomer, preferred are repeating units based on a perfluoromonomer in view of easiness of the reaction with fluorine gas described hereinafter and in view of durability of the electrolyte material, and more preferred are repeating units based on tetrafluoroethylene in view of availability of the monomer and high polymerizability of the monomer.

The amount of the repeating units based on another monomer is preferably from 5 to 85 mol %, more preferably from 10 to 80 mol %, particularly preferably from 10 to 70 mol % of the entire repeating units (100 mol %). Further, in order to obtain an electrolyte material having a high softening temperature, it is preferably from 10 to 70 mol %, more preferably from 10 to 60 mol %, particularly preferably from 10 to 50 mol %. When the amount of the repeating units based on another monomer is at least 5 mol %, when the resulting electrolyte material is used as an electrolyte membrane, the electrolyte membrane has sufficient toughness. When the amount of the repeating units based on another monomer is at most 85 mol %, an electrolyte material having sufficient electrical conductivity (ion exchange capacity) and a high softening temperature will be obtained.

The ion exchange capacity of the electrolyte material of the present invention is preferably from 0.7 to 2.5 meq/g dry polymer, more preferably from 0.9 to 1.5 meq/g dry polymer. When the ion exchange capacity of the electrolyte material is at least 0.7 meq/g dry polymer, the electrolyte material will have sufficient electrical conductivity. When the ion exchange capacity of the electrolyte material is at most 2.5 meq/g dry polymer, the electrolyte material will have favorable water repellency, and when used as an electrolyte membrane or a catalyst layer for a polymer electrolyte fuel cell, the electrolyte membrane or the catalyst layer will have sufficient durability. Further, when the ion exchange capacity of the electrolyte material is at most 2.5 meq/g dry polymer, the electrolyte material will have sufficient strength.

The ion exchange capacity of the electrolyte material is represented by the amount of —SO₂Y groups contained in 1 g of a dry polymer. As a method to determine the ion exchange capacity of the electrolyte material, an analysis method by alkali titration of the obtained electrolyte material, or in a case where a polymer having —SO₂F groups is obtained as disclosed in this specification, a method of subjecting the polymer to composition analysis by e.g. ¹⁹F-NMR to calculate the ion exchange capacity, for example, may be mentioned.

The weight average molecular weight of the electrolyte material of the present invention is preferably from 20,000 to 2,000,000, more preferably from 300,000 to 1,000,000. When the weight average molecular weight of the electrolyte material is at least 20,000, when the electrolyte material is used for an electrolyte material or a catalyst layer of a polymer electrolyte fuel cell, the electrolyte membrane or the catalyst layer will have sufficient strength. When the weight average molecular weight of the electrolyte material is at most 2,000,000, favorable moldability and solubility in a solvent will be achieved.

The molecular weight of the electrolyte material is obtained as a weight average molecular weight by analysis employing GPC. In the present invention, the molecular weight is meant for a molecular weight determined by using PL gel 10 μm MIXED-B manufactured by Polymer Laboratories Ltd. as a column, using perfluorophenanthrene as a solvent, at an oven temperature of 180° C.

The softening temperature of the electrolyte material of the present invention is preferably at least 100° C., more preferably at least 110° C., particularly preferably at least 120° C. When the softening temperature of the electrolyte material is at least 100° C., when the electrolyte material is used for an electrolyte material or a catalyst layer of a polymer electrolyte fuel cell, the fuel cell can be operated at a relatively high temperature of at least 100° C.

The softening temperature of the electrolyte material can be measured by dynamic viscoelasticity measuring method. Specifically, an electrolyte membrane converted to an acid form is subjected to dynamic viscoelasticity measurement at a frequency of 1 Hz at a heating rate of from 1 to 2° C./min, whereupon the maximum of the loss modulus is taken as the softening temperature. Here, dynamic viscoelasticity measurement is difficult on some of electrolyte materials. With respect to such an electrolyte material, the softening temperature can be measured by a method of measuring the penetration depth when a load is applied to the electrolyte material by a probe with heating by using TMA (for example, product by Mac Science Company).

### (Process for Producing Electrolyte Material)

The electrolyte material of the present invention can be produced, for example, via the following steps.

(a) A step of polymerizing a monomer mixture containing a compound (3) and a compound (4) and as the case requires, another monomer to obtain an electrolyte material precursor containing —SO₂F groups:

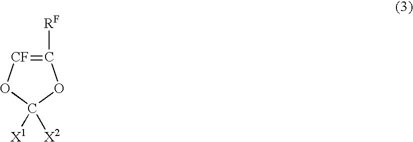

wherein R^{F} is a fluorine atom, a C₁₋₈ perfluoroalkyl group or a C₁₋₈ perfluoroalkoxy group, and each of X¹ and X² which are independent from each other, is a fluorine atom or a trifluoromethyl group,

CF₂═CF—O(CF₂)ₘ—SO₂F (4)

wherein m is an integer of from 2 to 4.

(b) A step of bringing the electrolyte material precursor and fluorine gas into contact with each other as the case requires to fluorinate unstable terminal groups of the electrolyte material precursor.

(c) A step of converting the —SO₂F groups in the electrolyte material precursor to —SO₂Y groups to obtain an electrolyte material.

(d) A step of bringing the electrolyte material and fluorine gas into contact with each other as the case requires to fluorinate unstable terminal groups of the electrolyte material.

However, only either one of the steps (b) and (d) should be carried out, and it is preferred to carry out only the step (b) in view of easiness of fluorination and stability of the —SO₂Y groups.

### (Step (a))

The compound (3) may, for example, be compounds (3-1) to (3-4), and preferred is the compound (3-1) from such a viewpoint that the softening temperature of the electrolyte material to be obtained can be effectively increased even if the proportion of the repeating units (1) is low.

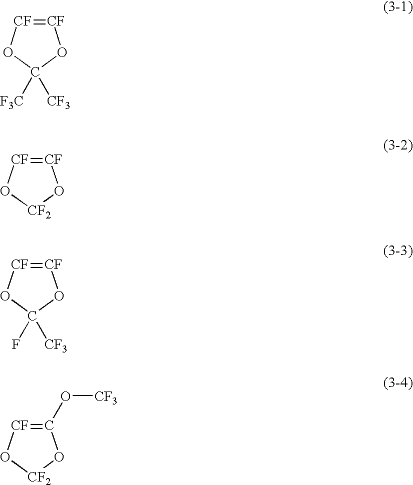

The compound (4) is preferably compound (4-1) from such a viewpoint that an electrolyte material having a higher softening temperature will easily be obtained, and a higher density of functional groups (—SO₂Y groups) can be achieved at the same proportion of the repeating units (2).

CF₂═CF—O(CF₂)₂—SO₂F (4-1)

Another monomer may, for example, be tetrafluoroethylene, chlorotrifluoroethylene, vinylidene fluoride, hexafluoropropylene, trifluoroethylene, vinyl fluoride, ethylene, or compounds (5) to (7):

CF₂═CFOR^{F1} (5)

CH₂═CHR^{F2} (6)

CH₂═CHCH₂R^{F2} (7)

wherein R^{F1} is a C₁₋₁₂ perfluoroalkyl group which may contain an etheric oxygen atom, and R^{F2} is a C₁₋₁₂ perfluoroalkyl group.

The compound (5) is preferably compound (5-1):

CF₂═CF—(OCF₂CFX)_{y}—O—R^{F4} (5-1)

wherein y is an integer of from 0 to 3, X is a fluorine is atom or a trifluoromethyl group, and R^{F4} is a C₁₋₁₂ perfluoroalkyl group.

The compound (5-1) is preferably compounds (5-1-1) to (5-1-3):

CF₂═CFO(CF₂)ₐCF₃ (5-1-1)

CF₂═CFOCF₂CF(CF₃)O(CF₂)_{b}CF₃ (5-1-2)

CF₂═CF(OCF₂CF(CF₃))_{c}O(CF₂)₂CF₃ (5-1-3)

wherein a is an integer of from 1 to 8, b is an integer of from 1 to 8, and c is 2 or 3.

As another monomer, preferred is a perfluoromonomer in view of easiness of the reaction of the resulted polymer with fluorine gas and in view of durability of the electrolyte material to be obtained, and more preferred is tetrafluoroethylene in view of availability and high polymerizability.

The polymerization method may be a known polymerization method such as bulk polymerization, solution polymerization, suspension polymerization or emulsion polymerization.

The polymerization is carried out under such a condition that radicals will be formed. The method to let radicals form may, for example, be a method of irradiation with radiation rays such as ultraviolet rays, γ-rays or electron rays, or a method of adding a radical initiator.

The polymerization temperature is usually from 20 to 150° C.

The radical initiator may, for example, be a bis(fluoroacyl) peroxide, a bis(chlorofluoroacyl) peroxide, a dialkyl peroxy dicarbonate, a diacyl peroxide, a peroxy ester, an azo compound or a persulfate. Preferred is a perfluoro compound such as a bis(fluoroacyl) peroxide, whereby an electrolyte material precursor with a small amount of unstable terminal groups will be obtained.

As a specific structure of a bis(fluoroacyl) peroxide, for example, a structure represented by R^{F5} COO—OOCR^{F5} may be mentioned, wherein R^{F5} is a C₁₋₁₀ perfluoroalkyl group which may contain an etheric oxygen atom.

The boiling point of the solvent used for solution polymerization is preferably from 20 to 350° C., more preferably from 40 to 150° C., in view of handling efficiency. The solvent may, for example, be a polyfluorotrialkylamine compound, a perfluoroalkane, a hydrofluoroalkane, a chlorofluoroalkane, a fluoroolefin having no double bond at terminals of the molecular chain, a polyfluorocycloalkane, a polyfluorocyclic ether compound, a hydrofluoroether, a fluorine-containing low molecular weight polyether or t-butanol. The solvents may be used alone or as a mixture of two or more of them. Liquid or supercritical carbon dioxide may also be used as the solvent.

### (Step (b))

The unstable terminal group is a group formed by chain transfer reaction, a group based on a radical initiator, or the like, and the polymer after polymerization usually has unstable terminal groups. Specifically, it may, for example, be the structure of a radical initiation species, a —COOH group, a —CF═CF₂ group, a —COF group or a —CF₂H group. By fluorination of the unstable terminal groups, decomposition of the electrolyte material can be suppressed even when it is used under severe conditions.

Fluorine gas may be used as diluted with an inert gas such as nitrogen, helium or carbon dioxide, or may be used as it is without dilution. In a case where it is diluted, the concentration of the fluorine gas is usually at least 0.1% and less than 100%.

The electrolyte material precursor may be in a bulk state or may be in a state where it is dispersed or dissolved in a fluorinated solvent.

The following solvents may be mentioned as the fluorinated solvent.

Polyfluorotrialkylamine compounds such as perfluorotributylamine and perfluorotripropylamine.

Fluoroalkanes such as perfluorohexane, perfluorooctane, perfluorodecane, prefluorododecane, perfluoro(2,7-dimethyloctane), 2H,3H-perfluoropentane, 1H-perfluorohexane, 1H-perlfluorooctane, 1H-perfluorodecane, 1H,4H-perfluorobutane, 1H,1H,1H,2H,2H-perfluorohexane, 1H,1H,1H,2H,2H-perfluorooctane, 1H,1H,1H,2H,2H-perfluorodecane, 3H,4H-perfluoro(2-methylpentane) and 2H,3H-perfluoro(2-methylpentane).

Chlorofluoroalkanes such as 3,3-dichloro-1,1,1,2,2-pentafluoropropane, 1,3-dichloro-1,1,2,2,3-pentafluoropropane and 1,1-dichloro-1-fluoroethane.

Polyfluorocycloalkanes such as perfluorodecalin, perfluorocyclohexane, perfluoro(1,2-dimethylcyclohexane), perfluoro(1,3-dimethylcyclohexane), perfluoro(1,3,5-trimethylcyclohexane) and perfluorodimethylcyclobutane (regardless of structural isomerism).

Polyfluorocyclic ether compounds such as perfluoro(2-butyltetrahydrofuran).

Hydrofluoroethers such as n-C₃F₇OCH₃, n-C₃F₇OCH₂CF₃, n-C₃F₇OCHFCF₃, n-C₃F₇OC₂H₅, n-C₄F₉OCH₃, iso-C₄F₉OCH₃, n-C₄F₉OC₂H₅, iso-C₄F₉OC₂H₅, n-C₄F₉OCH₂CF₃, n-C₅F₁₁OCH₃, n-C₆F₁₃OCH₃, n-C₅F₁₁OC₂H₅, CF₃OCF(CF₃)CF₂OCH₃, CF₃OCHFCH₂OCH₃, CF₃OCHFCH₂OC₂H₅ and n-C₃F₇OCF₂CF(CF₃)OCHFCF₃.

Fluorine-containing low molecular weight polyethers, an oligomer of chlorotrifluoroethylene, etc.

Fluorine-containing aromatic compounds such as hexafluorobenzene, trifluoromethylbenzene and 1,4-bistrifluoromethylbenzene.

Chlorofluorocarbons such as 1,1,2-trichloro-1,2,2-trifluoroethane, 1,1,1-trichloro-2,2,2-trifluoroethane, 1,1,1,3-tetrachloro-2,2,3,3-tetrafluoropropane, 1,1,3,4-tetrachloro-1,2,2,3,4,4-hexafluorobutane.

The fluorinated solvents may be used alone or as a mixture of two or more of them.

The fluorinated solvent is preferably a fluorinated solvent containing no hydrogenated atom, which will not react with fluorine gas.

As the fluorinated solvent, a chlorofluorocarbon is undesirable in view of environmental protection.

Liquid or supercritical carbon dioxide may be used instead of the fluorinated solvent.

The temperature when the electrolyte material precursor and fluorine gas are brought into contact is preferably from room temperature to 300° C., more preferably from 50 to 250° C., furthermore preferably from 100 to 220° C., particularly preferably from 150 to 200° C. When the temperature is at least room temperature, the reaction of unstable terminal groups of the electrolyte material precursor with fluorine gas will effectively proceed. When the temperature is at most 300° C., desorption of —SO₂F groups will be suppressed.

The time over which the electrolyte material precursor and fluorine gas are in contact is preferably from one minute to one week, more preferably from 1 to 50 hours.

### (Step (c))

In a case where Y of the —SO₂Y group is a hydroxyl group, the following step (c-1) is carried out, and in a case where Y is NHSO₂Z, the following step (c-2) is is carried out.

(c-1) A step of hydrolyzing the —SO₂F group of the electrolyte material precursor into a sulfonate, and converting the sulfonate into an acid form thereby to convert it into —SO₃H group.

(c-2) A step of converting the —SO₂F group of the electrolyte material precursor into sulfonimide thereby to convert it into a —SO₂NHSO₂Z group.

(Step (c-1))

The hydrolysis is carried out, for example, by bringing the electrolyte material precursor and a basic compound into contact with each other into a solvent.

The basic compound, may, for example, be sodium hydroxide or potassium hydroxide. The solvent may, for example, be water or a solvent mixture of water and a polar solvent. The polar solvent may, for example, be an alcohol (such as methanol or ethanol) or dimethyl sulfoxide.

The conversion into an acid form is carried out, for example, by bringing the electrolyte material precursor having the SO₂F group hydrolyzed into contact with an aqueous solution of e.g. hydrochloric acid or sulfuric acid.

The hydrolysis and the conversion into an acid form are carried out usually at from 0 to 120° C.

(Step (c-2))

The conversion into sulfonimide is carried out in accordance with a known method such as a method disclosed in U.S. Pat. No. 5,463,005, or a method disclosed in Inorg. Chem. 32 (23), page 5007 (1993).

The following processes may be mentioned as specific examples of the conversion into sulfonimide.

(c-2-1) A process of bringing the electrolyte material precursor and a perfluorosulfonamide (such as trifluoromethane sulfonamide, heptafluoroethane sulfonamide or nonafluorobutane sulfonamide) into contact with each other in the presence of a basic compound (such as an alkali metal fluoride or an organic amine), or bringing the electrolyte material precursor and a compound having an alkali metal salt of the above pefluorosulfonamide silylated into contact with each other, to convert the —SO₂F group of the electrolyte material precursor into a sulfonimide group in a salt form, and then converting the sulfonimide group in a salt form into an acid form thereby to convert it into a —SO₂NHSO₂Z group.

(c-2-2) A process of bringing the electrolyte material precursor and ammonia into contact with each other to convert the —SO₂F group of the electrolyte material precursor into a sulfonamide group, and further bringing it into contact with a —SO₂F group-containing compound (such as trifluoromethanesulfonyl fluoride, heptafluoroethanesuflonyl fluoride, nonafluorobutanesulfonyl fluoride or undecafluorocyclohexanesulfonyl fluoride) in the presence of a basic compound (such as an alkali metal fluoride or an organic amine) thereby to convert the sulfonamide group of the electrolyte material precursor into a —SO₂NHSO₂Z group.

The electrolyte material precursor at the time of the conversion into sulfonimide may be in a solid state, may be in a state where it is swollen in a solvent, or in a state where it is dissolved in a solvent. The electrolyte material precursor is preferably in a state where it is swollen in a solvent or a state where it is dissolved in a solvent, from such a viewpoint that the conversion into sulfonimide will be smoothly in progress. The solvent may be the fluorinated solvent used in the step (b).

Further, in addition to the fluorinated solvent, a solvent A containing no fluorine, a solvent B containing fluorine, or the like as described hereinafter is preferred as a solvent from such a viewpoint that the conversion into sulfonimide will be effectively in progress. The solvents may be used as a mixture of two or more of them, and a combination of the fluorinated solvent and the solvent A is preferred.

The solvent A may, for example, be a polar solvent such as acetonitrile, propionitrile, methanol, ethanol, 2-propanol, dimethyl sulfoxide, N,N-dimethylformamide, N,N-dimethylacetoamide or N-methyl-2-pyrrolidone; or an ether such as diethylene glycol dimethyl ether, tetraethylene glycol dimethyl ether, 1,4-dioxane or tetrahydrofuran.

The solvent B may be a fluorinated alcohol such as CF₃CH₂OH, CF₃CF₂CH₂OH, H(CF₂CF₂)_{d}CH₂OH, CF₃ (CF₂)ₑ(CH₂)_{f}OH or (CF₃)₂CHOH, wherein d is an integer of from 1 to 5, e is an integer of from 1 to 10 and f is an integer of from 1 to 6.

### (Step (d))

The step (d) may be carried out in the same manner as the step (b).

Here, in a case where the electrolyte material having —SO₂NHSO₂Z groups is fluorinated, since the NH bond in the —SO₂NHSO₂Z group will be converted into the NF bond, the NF bond must be converted into the NH bond.

As a method of converting the NF bond into the NH bond, for example, a known method employing e.g. a malonate or an aromatic compound may be mentioned.

### (Membrane-Electrode Assembly)

The electrolyte material of the present invention may be used as an electrolyte material of a membrane-electrode assembly for a polymer electrolyte fuel cell.

The membrane-electrode assembly comprises an electrolyte membrane and two electrodes (cathode and anode) to be disposed via the electrolyte membrane.

The electrode comprises a catalyst layer and a gas diffusion layer disposed so that the catalyst layer side is in contact with the electrolyte membrane.

The electrolyte material of the present invention may be contained in only one of the electrolyte membrane and the catalyst layer or may be contained in both of the electrolyte membrane and the catalyst layer. The electrolyte material of the present invention is preferably contained in both of the electrolyte membrane and the catalyst layer, whereby a high power density will be obtained and a fuel cell can be operated at a relatively high temperature of at least 100° C.

The electrolyte material of the present invention may be contained in the catalyst layer of only one of the cathode and the anode or may be contained the catalyst layer of both of the cathode and the anode. The electrolyte material of the present invention comprises a polymer having a cyclic structure in its main chain, whereby a cathode excellent in gas diffusion property and water repellency will be obtained. Therefore, the electrolyte material of the present invention is preferably contained in at least the catalyst layer of the cathode, and it is preferably contained in the catalyst layer of both of the cathode and the anode, whereby a high power density will be obtained and a fuel cell can be operated at a relatively high temperature of at least 100° C.

The membrane-electrode assembly may be produced, for example, by the following steps.

(x) A step of producing an electrolyte membrane.

(y) A step of preparing a liquid composition containing the electrolyte material and dispersing a catalyst in the liquid composition to prepare a catalyst dispersion.

(z) A step of forming a catalyst layer employing the catalyst dispersion to obtain a membrane-electrode assembly.

### (Step (x))

As the electrolyte material, the electrolyte material of the present invention may be used, or a known electrolyte material (ion exchange resin) may be used. The electrolyte material is preferably the material of the present invention, whereby a high power density will be obtained and a fuel cell can be operated at a relatively high temperature of at least 100° C.

The known electrolyte material may, for example, be an electrolyte material obtained by hydrolyzing a copolymer of tetrafluoroethylene with compound (8) and converting it into an acid form:

CF₂═CF—(OCF₂CFY¹)_{q}—Oₚ—(CF₂)ₙ—SO₂F (8)

wherein Y¹ is a fluorine atom or a trifluoromethyl group, q is an integer of from 0 to 3, n is an integer of from 1 to 12, and p is 0 or 1, provided that q+p>0.

The electrolyte membrane may be produced, for example, by the following method.

(x-1) A method of forming the electrolyte material precursor obtained in the above step (a) into a membrane, followed by the above step (c).

(x-2) A method of forming the electrolyte material obtained in the above step (c) into a membrane.

### (Step (y))

The electrolyte material may be the electrolyte material of the present invention or a known electrolyte material (ion exchange resin). The electrolyte material is preferably the electrolyte material of the present invention, whereby a high power density will be obtained and a fuel cell can be operated at a relatively high temperature of at least 100° C.

The electrolyte material may be a mixture of the electrolyte material of the present invention with a known electrolyte material. The proportion of the electrolyte material of the present invention is at least 20 mass %, more preferably at least 50 mass % of the mixture (100 mass %).

The liquid composition may be prepared by dissolving or dispersing the electrolyte material in a solvent.

The solvent is preferably an organic solvent having a hydroxyl group, in which the electrolyte material can be well dissolved or dispersed. Such a solvent may, for example, be methanol, ethanol, 1-propanol, 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol, 3,3,4,4,5,5,6,6,7,7,8,8,8-tridecafluoro-1-octanol. The solvents may be used alone or as a mixture of two or more of them.

The solvent may be a solvent mixture of an organic solvent having a hydroxyl group with water or another fluorinated solvent. Another fluorinated solvent may be the fluorinated solvent used in the above step (b). The proportion of the organic solvent having a hydroxyl group is preferably at least 10 mass %, more preferably at least 20 mass % of the solvent mixture (100 mass %).

In a case where the solvent mixture is used, the electrolyte material may be dissolved or dispersed in the solvent mixture, or the electrolyte material may be dissolved or dispersed in the organic solvent having a hydroxyl group, and then water or another fluorinated solvent is added.

The solvent may be an organic solvent having a carboxyl group (such as acetic acid).

Further, a liquid composition (aqueous dispersion) containing substantially no organic solvent may be prepared by dissolving or dispersing the electrolyte material in an organic solvent having a hydroxyl group and having a boiling point lower than that of water, adding water thereto and distilling the organic solvent having a hydroxyl group off.

The temperature at the time of preparation of the is liquid composition is preferably from 0 to 250° C., more preferably from 20 to 150° C. Preparation of the liquid composition may be carried out under the atmospheric pressure or under the condition of seal-off pressure by means of an autoclave or the like.

The concentration of the electrolyte material is preferably from 1 to 50 mass %, more preferably from 3 to 30 mass % in the liquid composition (100 mass %). When the concentration of the electrolyte material is at least 1 mass %, the amount of the solvent can be suppressed small. When the concentration of the electrolyte material is at most 50 mass %, the viscosity of the liquid composition can be suppressed low, whereby favorable handling efficiency will be achieved.

The catalyst dispersion is prepared by dispersing the catalyst in the liquid composition.

The catalyst may, for example, be a supported catalyst having fine platinum catalyst particles supported by an electrically conductive carbon black powder.

The ratio of the catalyst to the electrolyte material (catalyst/electrolyte material) is preferably from 40/60 to 95/5 (mass ratio) in view of the electrical conductivity of the electrode and water discharge property. In the case of the supported catalyst, the mass of the catalyst includes the mass of the carrier.

### (Step (z))

As a method of forming a catalyst layer by using the catalyst dispersion to obtain a membrane-electrode assembly, the following methods may be mentioned.

(z-1) A method of applying the catalyst dispersion to both surfaces of the electrolyte material and drying it to form catalyst layers, and bonding gas diffusion layers to the catalyst layers.

(z-2) A method of applying the catalyst dispersion to the surface of gas diffusion layers and drying it to form catalyst layers thereby to obtain electrodes, and bonding the electrodes to the electrolyte membrane.

By forming catalyst layers by the above method, electrodes excellent in gas diffusion property and water repellency will be obtained.

The gas diffusion layer may, for example, be carbon cloth or carbon paper.

The membrane-electrode assembly is used for a polymer electrolyte fuel cell. A polymer electrolyte fuel cell is produced, for example, by assembling the membrane-electrode assembly into a cell in a state where it is sandwiched between two separators.

A separator may, for example, be an electrically conductive carbon plate having grooves formed to constitute flow paths for a fuel gas or an oxidizing gas containing oxygen (such as air or oxygen).

The type of the polymer electrolyte fuel cell may, for example, be a hydrogen/oxygen type fuel cell or a is direct methanol type fuel cell (DMFC).

The electrolyte material of the present invention described above comprises a copolymer containing repeating units (1) and repeating units (2), and thereby has high electrical conductivity (ion exchange capacity) and a high softening temperature. Further, by using this electrolyte material, a membrane-electrode assembly and a polymer electrolyte fuel cell, whereby a high power density will be obtained and operation at a relatively high temperature of at least 100° C. is possible, can be obtained.

Now, the present invention will be described in further detail with reference to Examples. However, the present invention is by no means restricted to such specific Examples.

Examples 1 and 2 are Examples of the present invention, and Examples 3 and 4 are Comparative Examples.

### (Softening Temperature)

With respect to an electrolyte membrane comprising an electrolyte material, dynamic viscoelasticity measurement was carried out at a frequency of 1 Hz at a heating rate of from 1 to 2° C./min, and the maximum of the loss modulus was taken as the softening temperature.

### (Specific Resistivity)

With respect to the surface of an electrolyte membrane comprising an electrolyte material, the specific resistivity measurement was carried out at a temperature of 80° C. under a relative humidity of 90% by a four terminal method at a frequency of 10 kHz at a voltage of 1 V.

### (Ion Exchange Capacity)

From results of composition analysis determined by ¹⁹F-NMR, the amount of SO₂F groups contained in 1 g of a polymer was calculated to determine the ion exchange capacity.

### (Weight Average Molecular Weight)

The weight average molecular weight was determined by analysis employing GPC. Analysis was carried out by using PL gel 10 μm MIXED-B manufacture by Polymer Laboratories Ltd. as a column and using perfluorophenanthrene as a solvent at an oven temperature of 180° C.

### Example 1

A pressure resistant autoclave was depressurized, and 0.94 g of the compound (3-1) and 6.41 g of the compound (4-1) were charged into the autoclave, and the internal temperature was adjusted at 21° C.

Then, to the pressure resistant autoclave, tetrafluoroethylene was fed under a pressure of 0.2 MPa and further a solution having 2.8 mg of the compound (10) as a radical initiator dissolved in 0.358 g of the compound (9) (HCFC225cb manufactured by Asahi Glass Company, Limited) was fed to initiate the polymerization.

CClF₂CF₂CHClF (9)

CF₃CF₂CF₂OCF(CF₃)CF₂OCF(CF₃)C(═O)OOC(═O)CF(CF₃)OCF—(CF₃)OCF₂CF₂CF₂CF₃ (10)

Polymerization was carried out at 21° C. for 8 hours while 0.25 g of the compound (3-1) and 0.25 g of compound (4-1) were fed to the pressure resistant autoclave in ten steps of equal mass every 45 minutes. To stop the polymerization, 0.51 mg to Topanol dissolved in 510 mg of compound (9) was added to the reaction mixture, and the pressure was reduced to ambient conditions. After the residual pressure was purged, the reaction mixture was removed from the pressure resistant autoclave and hexane was added to precipitate the resulting copolymer. The copolymer was washed with hexane again, followed by vacuum drying to recover 0.49 g of the copolymer (electrolyte material precursor).

The ratio of repeating units constituting the copolymer was analyzed by ¹⁹F-NMR and as a result, repeating units based on tetrafluoroethylene/repeating units based on the compound (3-1)/repeating units based on the compound (4-1)=47/32/21 (molar ratio).

The copolymer was pressed into a film to obtain a membrane. This membrane was immersed in a solution of potassium hydroxide/water/dimethyl sulfoxide=14/58/28 (mass ratio) and maintained at 90° C. for 17 hours. The membrane was recovered to room temperature and washed with water three times. This membrane was immersed in 2N sulfuric acid at room temperature for 2 hours and washed with water. Immersion in sulfuric acid and washing with water were carried out respectively three times in total, and finally, the membrane was further washed with water three times. The membrane was air dried at 80° C. for 16 hours and further vacuum dried at 80° C. to obtain an electrolyte membrane (electrolyte material) having the ratio of repeating units such that repeating units based on tetrafluoroethylene/repeating units (1-1)/repeating units (2-1)=47/32/21 (molar ratio). With respect to the electrolyte membrane (electrolyte material), the softening temperature, the specific resistivity, the ion exchange capacity and the weight average molecular weight were measured. The results are shown in Table 1.

### Example 2

The pressure resistant autoclave was depressurized, and 0.71 g of the compound (3-1) and 6.70 g of the compound (4-1) were charged into the autoclave, and the internal temperature was adjusted at 21° C.

Then, tetrafluoroethylene was fed to the pressure resistant autoclave under a pressure of 0.2 MPa and further a solution having 2.8 mg of the compound (10) dissolved in 0.353 g of the compound (9) was fed to initiate the polymerization.

Polymerization was carried out at 21° C. for 8 hours while 0.19 g of the compound (3-1) and 0.19 g of compound (4-1) were fed to the pressure resistant autoclave in ten steps of equal mass every 45 minutes. To stop the polymerization, 0.50 mg to Topanol dissolved in 251 mg of compound (9) was added to the reaction mixture, and the pressure was reduced to ambient conditions. After the residual pressure was purged, the reaction mixture was removed from the pressure resistant autoclave and hexane was added to precipitate the resulting copolymer. The copolymer was washed with hexane again, followed by vacuum drying to recover the copolymer (electrolyte material precursor). The production of the copolymer was carried out three times in total to recover totally 1.48 g of the copolymer.

The ratio of repeating units constituting the copolymer was analyzed by ¹⁹F-NMR and as a result, repeating units based on tetrafluoroethylene/repeating units based on the compound (3-1)/repeating units based on the compound (4-1)=51/26/23 (molar ratio).

An electrolyte membrane (electrolyte material) having the ratio of repeating units such that repeating units based on tetrafluoroethylene/repeating units (1-1)/repeating units (2-1)=51/26/23 (molar ratio) was obtained in the same manner as in Example 1 except that the above copolymer was used. With respect to the electrolyte membrane (electrolyte material), the softening temperature, the specific resistivity, the ion exchange capacity and weight average molecular weight were measured. The results are shown in Table 1.

### Example 3

is A pressure resistant autoclave was depressurized, and 0.65 g of the compound (3-1) and 7.107 g of the compound (8-1) were charged into the autoclave, and the internal temperature was adjusted at 21° C.

CF₂═CF—OCF₂CF(CF₃)—O—(CF₂)₂—SO₂F (8-1)

Then, to the pressure resistant autoclave, tetrafluoroethylene was fed under a pressure of 0.107 MPa and further a solution having 1.9 mg of the compound (10) dissolved in 0.74 g of the compound (9) was fed to initiate the polymerization.

Polymerization was carried out at 21° C. for 8 hours while 0.17 g of the compound (3-1) and 0.17 g of compound (8-1) were fed to the pressure resistant autoclave in ten steps of equal mass every 45 minutes. To stop the polymerization, 0.35 mg to Topanol dissolved in 350 mg of compound (9) was added to the reaction mixture, and the pressure was reduced to ambient conditions. After the residual pressure was purged, the reaction mixture was removed from the pressure resistant autoclave and hexane was added to precipitate the resulting copolymer. The copolymer was washed with hexane again, followed by vacuum drying to recover 0.41 g of the copolymer (electrolyte material precursor).

The ratio of repeating units constituting the copolymer was analyzed by ¹⁹F-NMR and as a result, repeating units based on tetrafluoroethylene/repeating units based on the compound (3-1)/repeating units based on the compound (8-1)=39/35/26 (molar ratio).

The copolymer was pressed into a film to obtain a membrane. This membrane was immersed in a solution of potassium hydroxide/water/dimethyl sulfoxide=15/65/20 (mass ratio) and maintained at 90° C. for 17 hours. The membrane was recovered to room temperature and washed with water three times. This membrane was immersed in 2N sulfuric acid at room temperature for 2 hours and washed with water. Immersion in sulfuric acid and washing with water were carried out respectively three times in total, and finally, the membrane was further washed with water three times. The membrane was air dried at 80° C. for 16 hours and further vacuum dried at 80° C. to obtain an electrolyte membrane (electrolyte material). With respect to the electrolyte membrane (electrolyte material), the softening temperature, the specific resistivity, the ion exchange capacity and the weight average molecular weight were measured. The results are shown in Table 1.

### Example 4

A pressure resistant autoclave was depressurized, and 0.99 g of the compound (3-1) and 6.58 g of the compound (8-1) were charged into the autoclave, and the internal temperature was adjusted at 21° C.

Then, to the pressure resistant autoclave, tetrafluoroethylene was fed under a pressure of 0.062 MPa and further a solution having 0.6 mg of the compound (10) dissolved in 0.37 g of the compound (9) was fed to initiate the polymerization.

Polymerization was carried out at 21° C. for 8 hours while 0.26 g of the compound (3-1) and 0.26 g of compound (8-1) were fed to the pressure resistant autoclave in ten steps of equal mass every 45 minutes. To stop the polymerization, 0.11 mg to Topanol dissolved in 156 mg of compound (9) was added to the reaction mixture, and the pressure was reduced to ambient conditions. After the residual pressure was purged, the reaction mixture was removed from the pressure resistant autoclave and hexane was added to precipitate the resulting copolymer. The copolymer was washed with hexane again, followed by vacuum drying to recover 0.24 g of the copolymer (electrolyte material precursor).

The ratio of repeating units constituting the copolymer was analyzed by ¹⁹F-NMR and as a result, repeating units based on tetrafluoroethylene/repeating units based on the compound (3-1)/repeating units based on the compound (8-1)=32/46/22 (molar ratio).

An electrolyte membrane (electrolyte material) was obtained in the same manner as in Example 3 except that the above copolymer was used. With respect to the electrolyte membrane (electrolyte material), the softening temperature, the specific resistivity, the ion exchange capacity and the weight average molecular weight were measured. The results are shown in Table 1.

TABLE 1

| | Repeating units (mol %) | | | | | | Weight | Ion exchange |
|---|---|---|---|---|---|---|---|---|
| | in electrolyte material | | | | Softening | Specific | average | capacity |
| | precursor | | | | temperature | resistivity | molecular | (meq/g dry |
| | TFE | (3-1) | (4-1) | (8-1) | (° C.) | (Ω cm) | weight | polymer) |
| Ex. 1 | 47 | 32 | 21 | — | 135 | 5.1 | 380,000 | 1.14 |
| Ex. 2 | 51 | 26 | 23 | — | 128 | 3.7 | 300,000 | 1.29 |
| Ex. 3 | 39 | 35 | — | 26 | 116 | 5.3 | 310,000 | 1.08 |
| Ex. 4 | 32 | 46 | — | 22 | 137 | 8.0 | 440,000 | 0.91 |

It is understood from the results shown in Table 1 that by comparison between the electrolyte material of the present invention having repeating units based on the compound (4-1) converted into an acid form and a conventional electrolyte material having repeating units based on the compound (8-1) converted into an acid form, the electrolyte material of the present invention has a higher softening temperature when the molar ratio of the repeating units based on the compound (4-1) is at the same level (Examples 1 to 3) as the molar ratio of the repeating units based on the compound (8-1). Further, when it is desired to obtain an electrolyte membrane having a high softening temperature and a low specific resistivity by using a conventional electrolyte material, it is required to use expensive compounds (8-1) and (3-1) in a large amount as shown in Example 4. Whereas, with the electrolyte material of the present invention which employs the compound (4-1) instead of the compound (8-1), an electrolyte membrane having a high softening temperature and a low specific resistivity can be obtained with the amount of expensive compounds (4-1) and (3-1) suppressed.

The electrolyte material of the present invention is useful as an electrolyte material to be used for e.g. a membrane-electrode assembly for a polymer electrolyte fuel cell.

What is claimed is:

1. An electrolyte material comprising a copolymer containing repeating units represented by the following formula (1) and repeating units represented by the following formula (2): 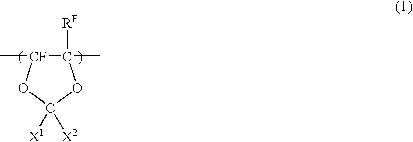
wherein R^{F} is a fluorine atom, a C₁₋₈ perfluoroalkyl group or a C₁₋₈ perfluoroalkoxy group, and each of X¹ and X² which are independent of each other, is a fluorine atom or a trifluoromethyl group, 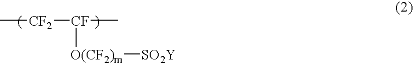
wherein m is an integer of from 2 to 4, and Y is a hydroxyl group or NHSO₂Z, wherein Z is a C₁₋₆ perfluoroalkyl group which may contain an etheric oxygen is atom.

2. The electrolyte material according to claim 1, wherein the repeating units represented by the above formula (1) are repeating units represented by the following formula (1-1):

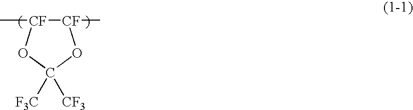

3. The electrolyte material according to claim 1, which contains from 0.5 to 80 mol % of the repeating units represented by the above formula (1) and from 5 to 40 mol % of the repeating units represented by the above formula (2).

4. The electrolyte material according to claim 1, which further contains repeating units based on tetrafluoroethylene.

5. The electrolyte material according to claim 4, which contains from 0.5 to 75 mol % of the repeating units represented by the above formula (1), from 5 to 40 mol % of the repeating units represented by the above formula (2), and from 5 to 85 mol % of the repeating units based on tetrafluoroethylene.

6. The electrolyte material according to claim 1, which has an ion exchange capacity of from 0.7 to 2.5 meq/g dry polymer.

7. The electrolyte material according to claim 1, which has a weight average molecular weight of from 20,000 to 2,000,000.

8. The electrolyte material according to claim 1, which is used as an electrolyte material for a membrane-electrode assembly for a polymer electrolyte fuel cell.
